(19) United States
(12) Patent Application Publication
(10) Pub. No.: US 2013/0252739 A1
(43) Pub. Date: Sep. 26, 2013

(54) SYSTEMS AND METHODS FOR CONFIGURING A GAMING MACHINE

(71) Applicant: Bally Gaming, Inc., Las Vegas, NV (US)

(72) Inventors: Shreekanthan Iyer, Las Vegas, NV (US); Shawn Falstrom, Las Vegas, NV (US); Alexander Villagran, Las Vegas, NV (US); Keith Lange, Las Vegas, NV (US)

(73) Assignee: Bally Gaming, Inc., Las Vegas, NV (US)

(21) Appl. No.: 13/896,496

(22) Filed: May 17, 2013

Related U.S. Application Data
(63) Continuation of application No. 12/758,768, filed on Apr. 12, 2010.

(51) Int. Cl. G06F 17/30

(52) U.S. Cl. CPC G06F 17/30283
USPC 463/42

(57) ABSTRACT

Systems and methods for configuring a gaming machine are disclosed herein. In one embodiment, the systems and methods reduce operator activity at a gaming machine in order to configure a default set of game packages. By selecting a pre-defined set of games in conjunction with a set of game denominations, the operator will be able to configure a complete game suite at one time on a gaming machine, thereby eliminating the need for the operator to configure each game profile individually.

### CROSS-REFERENCE TO RELATED APPLICATION

This application is a continuation application of and claims priority to U.S. application Ser. No. 12/758,768 filed Apr. 12, 2010 and titled “SYSTEMS AND METHODS FOR CONFIGURING A GAMING MACHINE”.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

Over the years, casinos have grown in size, grandeur, and amenities in order to attract gambling patrons. Additionally, casinos have attempted to provide gambling patrons with a wide variety of the new and exciting games. Given this demand, gaming machines have grown in sophistication and features in order to captivate and maintain player interest. As a result, casinos are able to provide a wide range and large number of games of chance. For example, a casino floor may include thousands of gaming machines that are in communication with and monitored by the casino's gaming network. Gaming machines provide an enhanced gaming experience with computer graphics, stereo sound, animation, and other features that have been developed to maintain player interest in the game for longer periods of time increasing minimum bet size, bet frequency, and speed of play. This, in turn, leads to the player wagering at the gaming machine for longer periods of time, with more money at a faster pace, thereby increasing owner profits.

Currently, casino operators use manual methods to alter content or to reconfigure gaming machines and/or other secondary networked devices. For example, a casino employee would need to manually swap out game media to change game content or the employee would need to access an attendant menu on the gaming machine to alter game configurations. Given the large number of machines and networked devices, this process is a time-consuming and costly process not only in terms of operating and/or maintenance costs, but also in terms of lost profits due to extended downtime for the gaming machines. Similarly, existing approaches for software updates or downloads for gaming machines are labor-intensive as costly as the gaming machines. For example, a technician typically needs to travel to the gaming machine in order to replace existing software package media (e.g., EPROMs, CD-ROM's, Compact Flash, etc.) with new software package media. Furthermore, the software package update process may require that the gaming machine be disabled hours in advance to prevent any players from using the gaming machine when the technician is ready to perform software package changes. Alternatively, gaming machines may be disabled prior to software package updates, but the technician must periodically check to ensure that the gaming machine(s) are not being used by a player. Additionally, technicians may need to be supervised during the process of software package installation as the technician has access to critical areas of the gaming machine required for configuration or of those areas of containing cash.

Accordingly, there is a need for systems and methods for an operator to configure a gaming machine.

### SUMMARY

Briefly, and in general terms, various embodiments are directed to systems and methods for configuring a gaming machine. In one embodiment, the systems and methods reduce operator activity at a gaming machine in order to configure a default set of games and game configurations. By selecting a pre-defined set of games in conjunction with a set of game denominations, the operator will be able to configure a complete game suite at one time, thereby eliminating the need for the operator to configure each game individually. This allows the manufacturer to provide recommendations through manufacturer suggested default configurations. Additionally, the system requires minimal changes to the gaming machine memory. In one embodiment, the gaming machine memory (e.g., compact flash) is changed by introducing a new XML file containing default configuration options for the games.

According to one method, a gaming machine is configured by providing access to a setup screen on a display of a gaming machine; initiating a default game configuration screen from the setup screen; enabling selection of a game package from a plurality of game packages presented on the default game configuration screen, the plurality of game packages stored in a memory device in the gaming machine, the game package includes one or more games having similar game themes and paytables; enabling selection of a game denomination set from a list of game denominations presented on the default game configuration screen, the list of game denominations stored in the memory device in the gaming machine; verifying that the selected game package and the selected game denomination set is valid, wherein the selected game package and the selected game denomination set form a configuration of the gaming machine; saving the selected configuration to a non-volatile memory; and presenting one or more games on a display of the gaming machine for play based on the selected configuration.

In another method, a gaming machine is configured by receiving operator input at a gaming machine, the operator input creating a default game configuration by selecting a game package and a game denomination set from a default list of game packages and game denomination sets; transmitting the selected default game configuration to a configuration manager; determining validity of the selected default game configuration at the configuration manager; adding the default game configuration to the gaming machine if the default game configuration is valid; and presenting one or more games on a display of the gaming machine based on the default game configuration.

In yet another method, one gaming machine within a system of similar gaming machines within reasonable proximity of each other is used as the Master copy of a common configuration. Various options are classified by the operating system as common (i.e. can be copied to other gaming machines) or identity-specific (i.e., applicable to the unique identity, serial number, communication port number, asset number or location of the gaming machine). Any common options set on the Master gaming machine can then be applied to all gaming machines requiring identical configuration. This may be performed by setting the Master gaming machine as a download and configuration host and using the G2S protocol or an application-specific protocol to transfer configuration data including, but not limited to, game configurations, hardware selections, and any other common gaming machine options.

In another method, one or more games on networked gaming machines within a gaming system are configured by providing access to a setup screen on a display of a first gaming machine; initiating a default game configuration screen from the setup screen; enabling selection of a game package from a plurality of game packages presented on the default game configuration screen, the plurality of game packages stored in a memory device in the first gaming machine, the game package includes one or more games having similar game themes and paytables; enabling selection of a game denomination set from a list of game denominations presented on the default game configuration screen, the list of game denominations stored in the memory device in the first gaming machine; verifying that the selected game package and the selected game denomination set is valid, wherein the selected game package and the selected game denomination set form a configuration of the first gaming machine; saving the selected configuration to a non-volatile memory on the first gaming machine; transmitting the selected configuration from the first gaming machine to one or more selected gaming machines in the gaming system in response to operator input; reconfiguring the selecting gaming machines according the selected configuration sent from the first gaming machine; and presenting one or more games on the displays of the gaming machines for play based on the selected configuration

Other features and advantages will become apparent from the following detailed description, taken in conjunction with the accompanying drawings, which illustrate by way of example, the features of the various embodiments.

### BRIEF DESCRIPTION OF THE DRAWINGS

FIG. 1 is a block diagram of one embodiment of a configuration management system.

FIG. 2 is a screen shot of one embodiment of a setup page for a gaming machine.

FIG. 3 is a screen shot of one embodiment of a default game configuration window.

FIG. 4 is a screen shot of another embodiment of a default game configuration window.

FIG. 5 is a screen shot of yet another embodiment of a default game configuration window.

FIG. 6 is a screen shot of one embodiment of an advanced game configuration window.

FIG. 7 is a flow chart of one method of using default configurations to configure a gaming machine.

FIG. 8 is a flow chart of another method of using default configurations to configure a gaming machine.

FIG. 9 is a perspective view of one embodiment of a gaming machine.

FIG. 10 is a block diagram of one embodiment of a network used by one embodiment of the configuration system.

FIG. 11 is a block diagram of another embodiment of a network used by one embodiment of the configuration system.

### DETAILED DESCRIPTION

Various embodiments are directed to systems and methods for configuring a gaming machine. In one embodiment, the systems and methods reduce operator activity at a gaming machine by pre-configuring a default set of game packages. By selecting a pre-defined set of games and a set of game denominations, the operator configures a complete game suite at one time, thereby eliminating the need for the operator to configure each game individually.

The default configuration system also provides flexibility and scalability for the configuration process. If the presence of a default configuration file is detected on a gaming machine during the configuration process, one or more default game sets are presented on the gaming machine. The default game set includes games having a similar game theme, base denomination, and jurisdictional compliance. Based on the selected game set, one or more denomination sets are presented to the operator for selection. Once a game set and denomination set are selected, the gaming machine is configured. Optionally, detailed configuration, fine-tuning, addition or subtraction of the result-time, and game-denomination combinations may be further altered from the default configuration. Accordingly, an operator has the ability to customize the gaming machine configuration. Thus, the default configuration system facilitates simplicity in configuring a gaming machine while also maintaining flexibility in customizing the configuration.

Additionally, the system requires minimal changes to the gaming machine memory. In one embodiment, the gaming machine memory (e.g., compact flash) is changed by introducing a new XML file containing default configuration options for the games. Alternatively, the file may be a binary or text file.

It should be noted that the term gaming machine is intended to encompass any type of gaming machine, including hand-held devices used as gaming machines such as cellular based devices (e.g. phones), PDAs, or the like. The gaming machine can be represented by any network node that can implement a game and is not limited to cabinet based machines. The system has equal applicability to gaming machines implemented as part of video gaming consoles or handheld or other portable devices. In one embodiment, a geo-location device in the handheld or portable gaming device may be used to locate a specific player for regulatory and other purposes. Geo-location techniques that can be used include by way of example, and not by way of limitation, IP address lookup, GPS, cell phone tower location, cell ID, known Wireless Access Point location, Wi-Fi connection used, phone number, physical wire or port on client device, or by middle tier or backend server accessed. In one embodiment, GPS and biometric devices are built within a player's client device, which in one embodiment, comprises a player's own personal computing device, or provided by the casino as an add-on device using USB, Bluetooth, IRDA, serial or other interface to the hardware to enable jurisdictionally compliant gaming, ensuring the location of play and the identity of the player. In another embodiment, the casino provides an entire personal computing device with these devices built in, such as a tablet type computing device, PDA, cell phone or other type of computing device capable of playing system games.

The default configuration system also allows a host (remote to the gaming machine) to carry out the configuration of one or more gaming machines. As a result, the default configuration system utilizes less network resources and time to configure a gaming machine. For example, any gaming machine having a configuration that reflects a combination of both unaltered default game set and denomination set combination, a complete configuration transfer is not necessary. Rather, the unaltered configuration data may be obtained on the gaming machine itself. In one embodiment, tags (i.e., certain code) may be used to specify the game set and denomination set that are unaltered. These tags signal the host that the configuration file for the game set or denomination set does not need to be downloaded to the gaming machine thereby reducing use of network resources.

In another embodiment, the configuration of one or more games on a networked gaming device is selected/configured at the gaming device. That is, a casino operator accesses the default configuration system at the gaming device. The selected configuration on this networked gaming device may then be communicated via the network to other gaming devices local to the configured gaming device. The local gaming devices may be in the same bank of gaming devices and/or on the same casino floor. Alternatively, the local gaming devices receiving the game configuration are based on other criteria such as, but not limited to, gaming cabinet type, games residing on the gaming device, gaming device OS, or other characteristics or criteria of the games or gaming device. In one embodiment, the selected configuration may also be checked for compatibility prior to sending the configuration to other gaming devices. Alternatively, the gaming device receiving the selected configuration checks the validity before reconfiguring the gaming device. The validity check ensures that the gaming device is capable of supporting the selected configuration changes. Optionally, when the selected configuration is received at the gaming device, the configuration is authenticated. As those skilled in the art will appreciate, any authentication method known or developed in the art may be used to authenticate the selected configuration. Once the selected configuration is received (and optionally validated and authenticated), the gaming device automatically reconfigures itself.

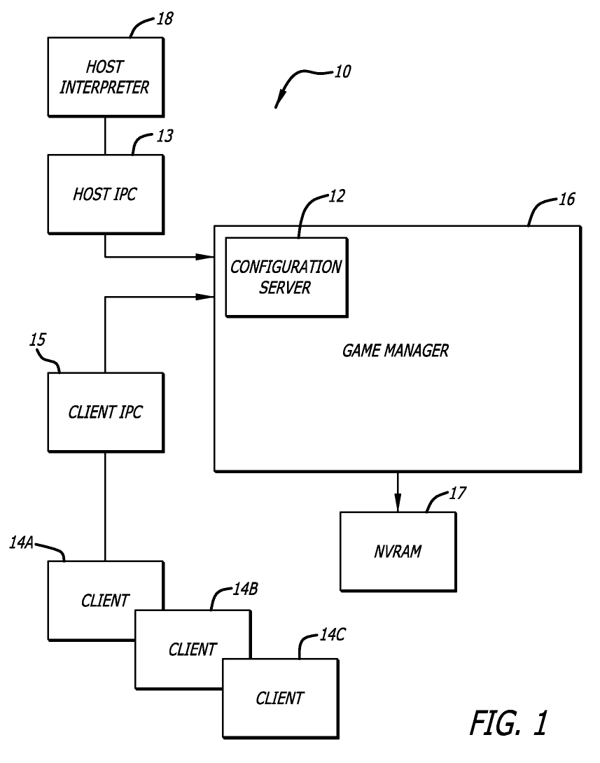

Referring now to the drawings, wherein like reference numerals denote like or corresponding parts throughout the drawings and, more particularly to FIGS. 1-6, there are shown various embodiments of a system for managing configurations of a gaming machine. FIG. 1 is a block diagram of an embodiment of a configuration management architecture that may be used in a gaming machine with the system 10. The architecture illustrates software functions within a gaming machine in one embodiment. A configuration process allows connections by internal and external clients through external communications protocols such as G2S or internal application interfaces or interprocess communication with other applications resident on the gaming machine. This may include remote procedure calls or simple communication protocol specified requests.

In one embodiment, the configuration server 12 acts as a central point of configuration management. The server 12 does not necessarily have specific knowledge of any specific configuration options. Rather, the server handles each configuration option dynamically as it is registered and used. It is the responsibility of the configuration client to register for a configuration and respond to a configuration change.

The configuration client's function is to provide a useful interface to the configuration service. The majority of these methods accept vectors of configuration objects to reduce calls and simplify the interface, as it is anticipated that most configuration clients may have multiple options to manage. Even though configuration objects may be created at any time, it is recommended that all configuration objects be registered before a “Game Complete” event. This allows host interpreters to have a consistent point of completeness, and provide a more consistent interface with the given host system.

As shown in FIG. 1, the configuration server 12 is a component of a game manager 16. With the configuration server 12 is a separate executable of the game manager 16, all of the other executables have equal functionality and capabilities of remote configuration. The configuration server 12 is able to maintain multiple connections with the configuration clients 14A-C and configuration host interpreters. The game manager 16 includes direct access to the game manager state. Alternatively, the configuration server 12 is a separate component from (yet still in communication with) the game manager 16.

The configuration server 12 includes connections to both clients and host interpreters. The clients are the users that register configuration options, and the clients receive call backs when changes are made to the configuration options.

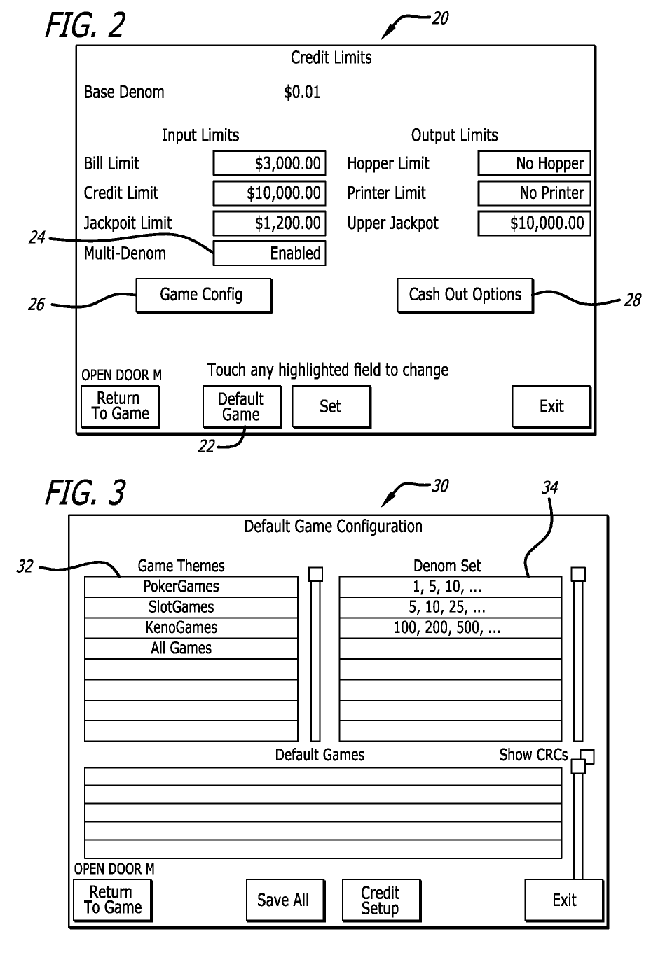

In one embodiment, the configuration client 14A-C is a gaming machine which is capable of presenting one or more games. In a configuration mode, the gaming machine may have one or more setup screens. As shown in FIGS. 2-6, a new Default Game Configuration screen may be created to present a list of preconfigured game packages and a list of pre-configured denomination sets to the operator for selection. As the operator makes a selection from each list, a detailed list of game paytables and denominations is presented. The operator may be able to save the default configuration selected or review the configuration by accessing the Game Configuration screen. The operator may also be able to make changes to the default configuration through the existing methods in Game Configuration.

FIG. 2 is a screen shot 20 of one embodiment of a credit setup screen on a gaming machine. If the Default Configuration feature is supported, the Operating System displays a “Default Game” button 22 on the Credit Setup screen. As shown in FIG. 2, the base denomination for a particular game is $0.01, and there are various input limit fields and output limit fields that may be configured by an operator. Specifically, input limits for bills, credits, and jackpots may be adjusted by the operator. The output limits that may be configured include but are not limited to hopper limit, printer limit, and upper jackpot limit. The credit setup page also includes a multi-denomination field 24, which is enabled as shown in FIG. 2. If Multi-Denom (i.e., multiple denomination option) is disabled, the “Default Game” button is also disabled. In FIG. 2, there are graphical depictions of buttons for Game Configuration 26 and Cash Out Options 28, which present additional fields in the same or new screen. At the bottom of the screen shot, a Default Game (or Default Game Configuration) button 22 is provided. The Default Game Configuration button 22 allows an operator to configure the gaming machine quickly.

The Default Game Configuration screen 30 is displayed when the operator selects the “Default Game” button on the Credit Setup screen. FIG. 3 illustrates a screen shot of one embodiment of the Default Game Configuration screen. On the screen shot, the Game Themes list 32 includes a list of game sets including but not limited to: Poker games, Slot games, Keno games, and All games. Additionally, there is a Denomination Set list 34 that includes sets of denominations that may be selected for the default game configuration. The Denomination Set list 34 is populated with sets containing the exact number of denominations as specified by the game set selected. Generally, the game denomination set list 34 is not populated until a game set has been selected. However, the game denomination set list 34 is refreshed each time a different game set is selected.

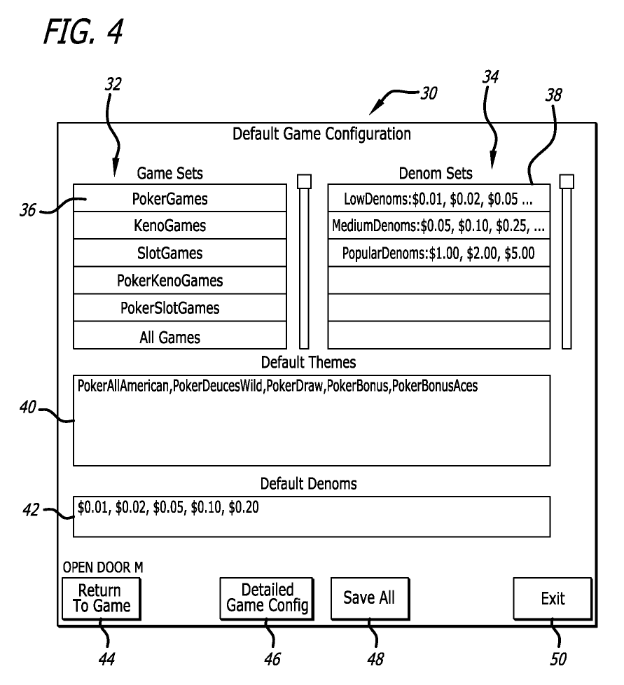

FIG. 4 illustrates a screen shot of the Default Game Configuration screen 30 in which the operator has selected a game package 36 and a denomination set 38. As the game package and denomination set are selected (e.g., Poker games and low denominations as shown in FIG. 4), the corresponding game themes and denomination ranges are displayed in the default theme information bar 40 and the default denomination information bar 42. Once a denomination set has been selected, an operator may be presented with the option to further refine the game options selected. The operator has the option to save the completed configuration without entering the Game Configuration screen. Once a game package set has been selected, operator has the option to further refine the game options. The operator may also choose to save the completed configuration without entering the Game Configuration screen.

In other embodiments, configuration information may be presented in a single information bar or area. Additionally, the information bar area may present warning messages regarding the loss of modifications to the default set up if a new selection is made or if there are any errors. An error message is presented if there is no valid denomination set for a selected game package. An error message may also be presented if no valid themes exist after selecting a game set. In the event that there are no valid themes after selecting a game set, the configuration screen does not display any denomination sets. When the game set and denomination set are selected in the Default Game Configuration screen and there is no denomination in denomination set that corresponds to the denomination index in the game, the paytable is not displayed.

The Default Game Configuration Screen also includes graphical depictions of buttons. In another embodiment, physical buttons or soft keys associated with a display may have the functions of the graphical buttons shown in FIG. 4. The “Return to Game” button 44 causes the gaming machine to exit all operator menus and return to either the active game or the game menu screen. A “Save All” button 46 shall save the default game configuration settings chosen by the operator into persistent memory. This button shall be enabled only if both a game set and game denomination set have been selected. An “Advanced Game Configuration” button 48 presents the operator with the Game Configuration screen. The Game Configuration screen shall contain the game slot information generated by the game set and denominations selected in the Default Game Configuration screen (if any). If the default game information is incomplete, the Game Configuration screen shall display zero (0) game slots. An “Exit” button 50 causes the gaming machine to return to the Credit Setup screen. If a default game configuration has been chosen but not saved into persisted memory when the “exit” button or “Return to Game” button are selected, the operator shall be prompted to save the configuration by selecting “Yes”, discard the changes by pressing “No”, or cancel the “exit” action by pressing “Cancel”.

In another embodiment, the Default Game Configuration screen may include one or more Game Setting Styles and/or Denomination Setting Styles. These setting styles provide a simplified set of configuration options for game settings and denomination settings. The Game Setting Styles and Denomination Setting Styles designate a collection of rules for default settings. Once a particular setting style is selected, typically, there is no need for additional configuration after a specific default configuration has been committed.

In one embodiment, a style name may be used to only identify a particular game set (e.g., Poker Only Cheapskate, Poker Only High Roller, Slots Only Cheapskate, Slots Only High Roller, Poker and Slots High Roller, Poker and Slots Cheapskate). Alternatively, the style name may be used to in multiple game sets (e.g., one or more game sets or denomination sets may be designated “cheapskate” or “high roller”). In another embodiment, the setting styles are preconfigured by the game developer and cannot be modified by the casino operator. Alternatively, a casino operator may configure and save a particular game set or denomination set under a style name for future use in other gaming machines.

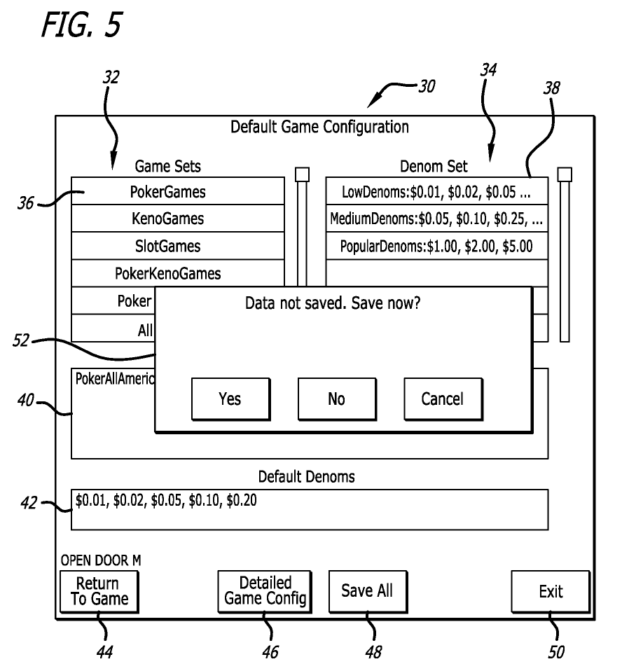

FIG. 5 illustrates one embodiment of a screen shot if the operator presses the “Return to Game” or “Exit” button on the Default Game Configuration Screen. In this embodiment, a confirmation window 52 with Yes/No/Cancel options for finalizing the configuration is displayed. The configuration gets saved as a final selection if the operator hits the “Yes” option. If the “No” option is selected, the game configuration details are not saved and the screen returns to the Credit Setup window. If the “Cancel” option is selected, the confirmation window closes and returns to the Default Game Configuration window.

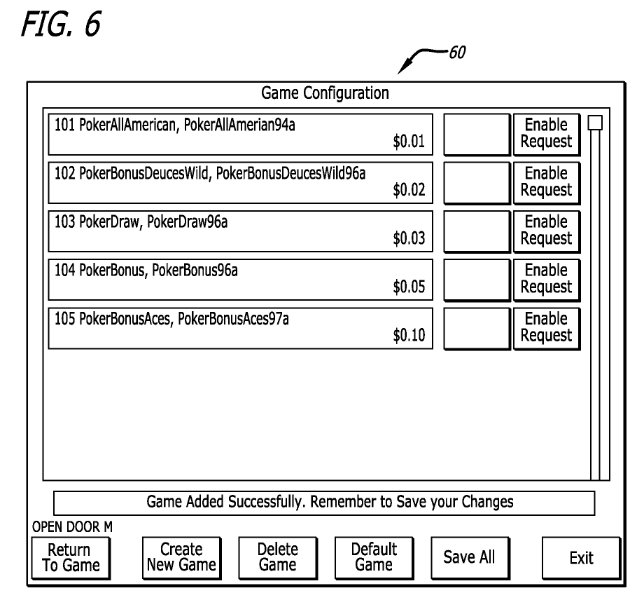

FIG. 6 illustrates one embodiment of a screen shot of a Game Configuration screen 60. This screen 60 is presented when the operator depresses the “Advanced Game Configuration” button or similar button on the same default screen 30. The Game Configuration screen 60 allows the operator to modify or delete configuration details. As shown in FIG. 6, the Game Configuration screen 60 includes the game slot information 62 generated by the game set and denominations selected in the default game configuration screen (if any). If the default game information is incomplete, the Game Configuration screen shall display zero (0) game slots. If the default game information is complete, each game slot shall contain one (1) paytable, its corresponding theme, and all of the denominations pertaining to the paytable contained in the denomination set. Additionally, if the default game information is complete, the total number of game slots displayed shall equal the number of Jurisdiction-valid paytables in the game set.

At the bottom of the screen shot shown in FIG. 6, there are various options such as, but not limited to, return to game, create new game, delete game, default game (which returns to the Default Game Configuration screen), Save All, and exit. Additionally, an information bar 64 is provided that presents status messages and/or other information such as, but not limited to, “Game added successfully. Remember to Save your Changes” as shown in FIG. 6.

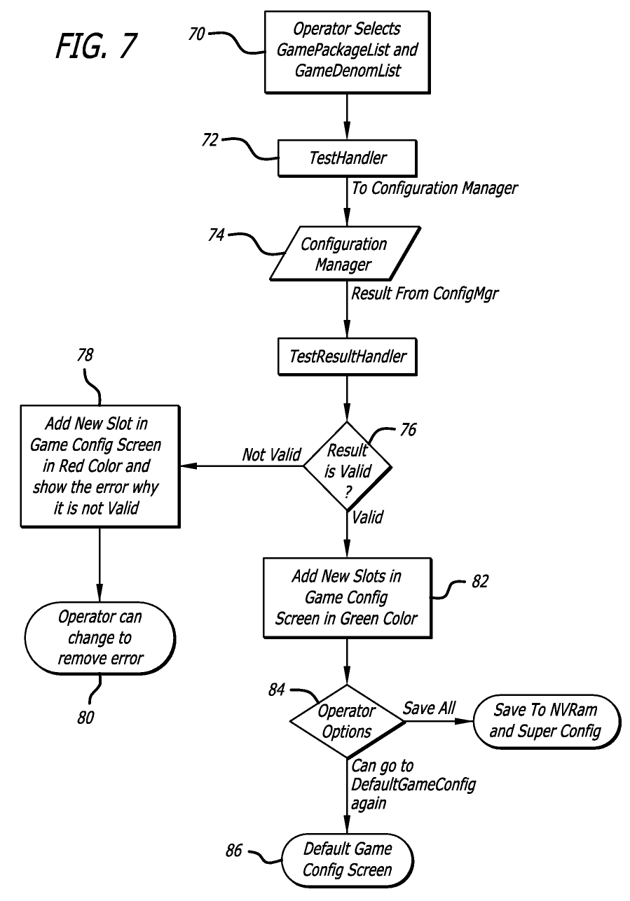

FIG. 7 is a flow chart illustrating one method of establishing and configuring a default configuration for a gaming machine. At step 70, the operator selects a game package list and a game denomination list. At step 72, the test handler receives the operator's selections and sends the request to the configuration manager. The configuration manager generates results based on the operator's selection and sends the results to the test result handler at step 74. At step 76, the validity of the result is determined. If the result is invalid, a New Slot is added in the game configuration screen at step 78, but the Slot is presented in a red color (or any other color) and/or an error message is presented as to the reason why the result is invalid, as shown in step 80. If the result is valid, one or more New Slots in the Game Configuration Screen are added in a green color at step 82 (or any other color). At step 84, the operator has the option to “save all,” and the configuration is saved to persisted memory and a configuration process on the gaming machine. Otherwise, the operator may return to the default game configuration screen at step 86.

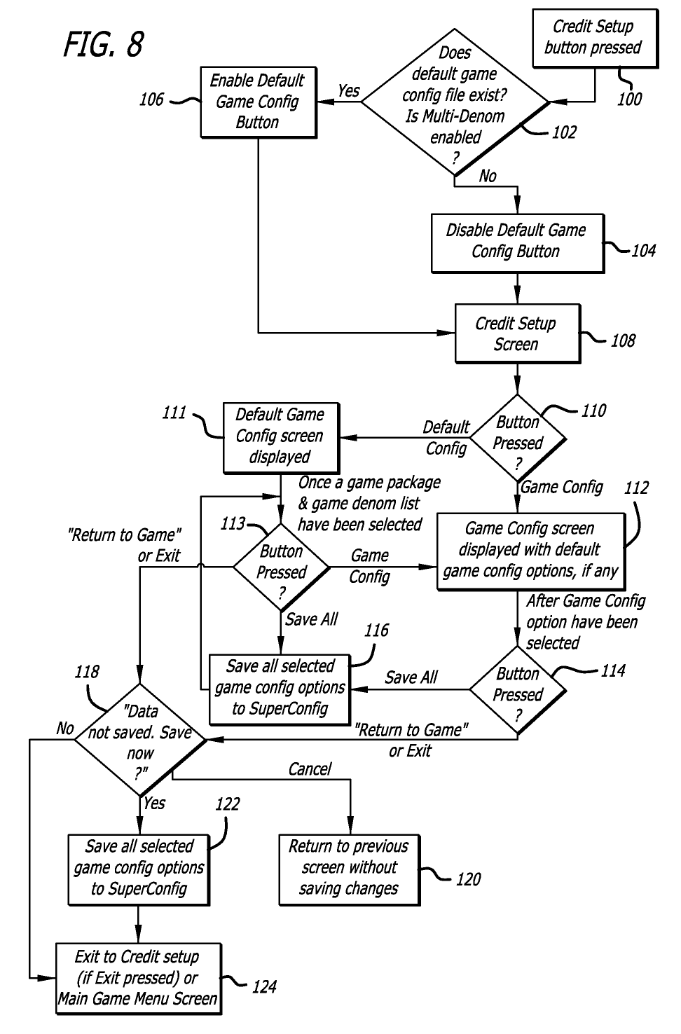

FIG. 8 is a flow illustrating another method of establishing and configuring a default configuration for a gaming machine. At step 100, the operator activates a credit setup button. At step 102, a determination is made to whether a default game configuration file exists. Additionally, a determination is made to whether multi-denom (i.e., multiple denominations option) is enabled on the gaming machine. If the answer is “no” to either question in step 102, the Default Game Configuration button is disabled at step 104. If the answer is “yes” to both questions in step 102, the Default Game Configuration button is enabled at step 106.

At the Credit Setup screen at step 108, if the button depressed at step 110 is the Game Configuration button, the Game Configuration screen is displayed with default game configuration options, at step 112. After the Game configuration options have been selected, if the save all button is pressed at step 114, then all of the selected game configuration options are saved to the configuration manager process in step 116. If the “return to game” or “exit” button is pressed at step 114, then a “Data not saved. Save now?” message is presented in step 118. If the save function is cancelled at step 118, then the display returns to the previous screen without saving changes at step 120. If the data is saved at step 118, then all selected game configuration options are saved to the configuration manager process at step 122. If the data is not saved at step 118, then the game configuration screen is exited to the Credit setup (if Exit is pressed) or the Main Game Menu Screen at step 124.

Alternatively, at the Credit Setup screen at step 108, if the button depressed is the Default Configuration button at step 110, the Default Game Configuration screen is displayed at step 111. Once a game package and game denomination list have been selected, if the save all button is pressed at step 113, then all of the selected game configuration options are saved to configuration manager process in step 116. If the “return to game” or “exit” button is pressed at step 113, then a “Data not saved. Save now?” message is presented in step 118. At this juncture, the operator has the option to save all, cancel function, or not save at this time.

According to one embodiment, the DefaultGameConfig.XML file resides in the Games folder in the memory of the gaming machine. In one embodiment, the gaming machine memory is a compact flash. The XML file contains the default values that shall be presented on the Configuration Screen, namely the game set list and the game denomination set list. In one embodiment, the XML file includes a GameSets section. This section contains the title and themes, pay tables, denomination sets and denomination codes that comprise each entry. Each game set shall also contain a field indicating the total number of denominations required for configuration. In other embodiments, the XML file supports automatic configuration of maximum bet and bet per lime for each game theme configured using the default game packages. Additionally, the XML file may have various denomination sets unique to each game package.

The DefaultGameConfig.XML may also have various sections that contain information including, but not limited to, a part number, XML version, date and timestamp section, and a gameSetList section. In one embodiment, the XML file has each game set entry residing in the gameSetList section, each denomSetList residing in the game set section, each denomination set entry residing in the denomSetList section, each game set entry having a title, each game set entry containing a minimum of one game theme, each game theme declared in a game set containing a minimum of one game paytable, each game paytable having a name, each game paytable having a minimum of one denomIndex, each denomIndex defined as a single, uppercase alphabetical character, each game denomination set entry having a title, each game denomination set entry having a minimum of one denomination, each denomination defined as a single numerical value ranging from 1 to 1000000000, or any combination thereof.

The default game configuration retrieves the information necessary from an XML file located on the Game compact flash (or other memory device located on the gaming machine). In one embodiment, the default game configuration file (i.e., DefaultGameConfig.XML) is compatible with the version of the XML parser on the gaming machine. Secondly, the default game configuration file contains a list of game packages and a list of game denomination sets. In one embodiment, the gaming machine's base denomination can be derived by the game denomination set selected.

In the same embodiments, multiple modules may have configuration options that have the same short name. For example, a game may have several “volumes” and the OS may also have its own volume. To manage this problem, a simple name to value pair is not sufficient because the management server needs to be able to distinguish between the different volumes. Accordingly, each configuration option name will include the path of the configuration file that the configuration option was created from. This reduces the restriction on option names to be unique per configuration file but now allows multiple “volumes” across the system.

If the default game configuration file exists, the OS can enable the Default Game Config button presented on a display, provided that the conditions that govern the ability to configure the machine are met. If the XML file does not exist, the Default Game Config button shall be hidden and disabled.

In one embodiment, the default configuration file also includes game package information. The game package information includes the title of each game package, a list of each game theme and paytable. The game package information is displayed in the information bar. In another embodiment, game denomination information is included with the XML file. The game denomination information generally is a list of selectable game denomination packages. In one embodiment, the first three denominations contained in each selection are displayed in the list of selectable game denomination packages. The game denomination package information is also displayed in the information bar.

When the Default Game Configuration screen is initially entered, the listbox display for the game denominations should be empty. The listbox is populated only after a game package has been selected, and only those denomination sets with a number of denominations equal to the number of denominations required by the game package are displayed and available for selection. In the event that a new game package is selected after a denomination set has been chosen, the game denomination listbox will be refreshed to contain those sets which meet the new requirements of the selected game package.

One of ordinary skill in the art will appreciate that not all systems for managing configurations of a gaming machine may have all these components and may have other components in addition to, or in lieu of, those components mentioned here. Furthermore, while these components are viewed and described separately, various components may be integrated into a single unit in some embodiments.

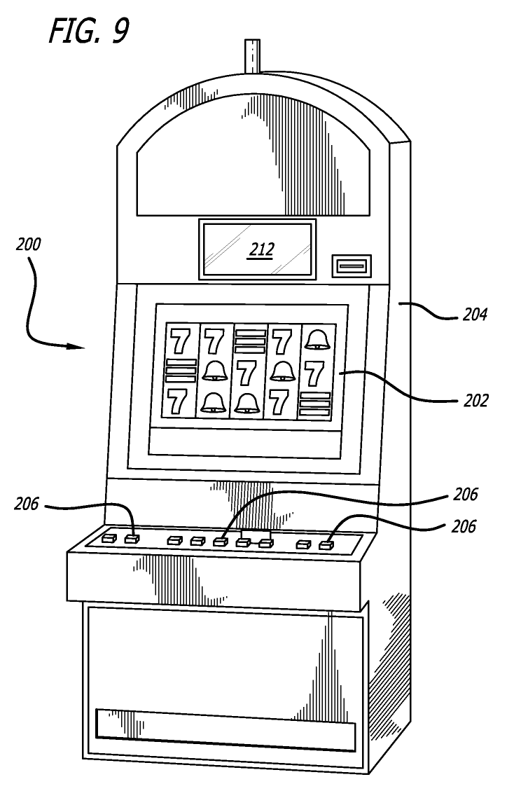

Turning to FIG. 9, the main cabinet 204 of the gaming machine 200 is a self-standing unit that is generally rectangular in shape. In another embodiment, the main cabinet 204 may be a slant-top gaming cabinet. Alternatively, in other embodiments, the gaming cabinet may be any shaped cabinet known or developed in the art that may include a top box. Additionally, the cabinet may be manufactured with reinforced steel or other rigid materials that are resistant to tampering and vandalism. Optionally, in an alternate embodiment, the gaming machine 200 may instead be a cinema-style gaming machine (not shown) having a widescreen display, as disclosed in U.S. application Ser. No. 11/225,827, entitled “Ergonomic Gaming Cabinet,” filed on Sep. 12, 2005, which is hereby incorporated by reference.

As shown in FIG. 9, the gaming machine 200 includes a main display 202. According to one embodiment, the main display 202 is a plurality of mechanical reels for presenting a slot-style game. Alternatively, the main display 202 is a video display for presenting one or more games such as, but not limited to, mechanical slots, video slots, video keno, video poker, video blackjack, video roulette, Class II bingo, games of skill, games of chance involving some player skill, or any combination thereof.

According to one embodiment, the main display 202 is a widescreen display (e.g., 16:9 or 16:10 aspect ratio display). In one embodiment, the display 202 is a flat panel display including by way of example only, and not by way of limitation, liquid crystal, plasma, electroluminescent, vacuum fluorescent, field emission, LCOS (liquid crystal on silicon), and SXRD (Silicon Xtal Reflective display), or any other type of panel display known or developed in the art. These flat panel displays may use panel technologies to provide digital quality images including by way of example only, and not by way of limitation, EDTV, HDTV, or DLP (Digital Light Processing).

According to one embodiment, the widescreen display 202 may be mounted in the gaming cabinet 204 in a portrait or landscape orientation. In another embodiment, the game display 202 may also include a touch screen or touch glass system (not shown). The touch screen system allows a player to input choices without using any electromechanical buttons 206. Alternatively, the touch screen system may be a supplement to the electromechanical buttons 206.

The main cabinet 204 of the gaming machine also houses a game management unit (not shown) that includes a CPU, circuitry, and software for receiving signals from the player-activated buttons 206 and a handle (not shown), operating the games, and transmitting signals to the respective game display 206 and speakers (not shown). Additionally, the gaming machine includes an operating system such as Bally Gaming's Alpha 05, as disclosed in U.S. Pat. No. 7,278,068, which is hereby incorporated by reference.

In various embodiments, game program may be stored in a memory (not shown) comprising a read only memory (ROM), volatile or non-volatile random access memory (RAM), a hard drive or flash memory device or any of several alternative types of single or multiple memory devices or structures.

As shown in FIG. 9, the gaming machine 200 includes a plurality of player-activated buttons 206. These buttons 206 may be used for various functions such as, but not limited to, selecting a wager denomination, selecting a number of games to be played, selecting the wager amount per game, initiating a game, or cashing out money from the gaming machine 200. The buttons 206 function as input mechanisms and may include mechanical buttons, electromechanical buttons or touch screen buttons. In another embodiment, one input mechanism is a universal button module that provides a dynamic button system adaptable for use with various games, as disclosed in U.S. application Ser. No. 11/106,212, entitled “Universal Button Module”, filed Apr. 14, 2005 and U.S. application Ser. No. 11/223,364, entitled “Universal Button Module”, filed Sep. 9, 2005, which are both hereby incorporated by reference. Additionally, other input devices, such as but not limited to, touch pad, track ball, mouse, switches, and toggle switches, are included with the gaming machine to also accept player input. Optionally, a handle (not shown) may be “pulled” by a player to initiate a slots-based game.

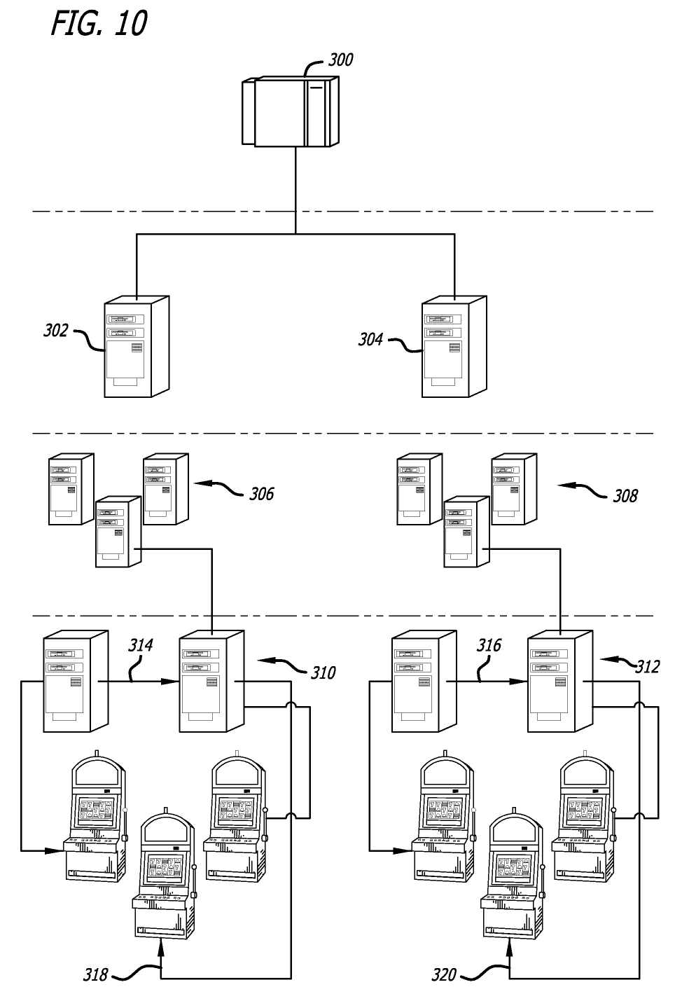

An embodiment of a network that may be used with the system is illustrated in FIG. 10. The example network consists of a top level vender distribution point 300 that contains all packages for all jurisdictions, one or more Jurisdiction distribution points 302 and 304 that contain regulator approved production signed packages used within that jurisdiction or sub-jurisdiction, one or more Software Management Points 306 and 308 to schedule and control the downloading of packages to the gaming machine and a one or more Software Distribution Points 310 and 312 that contain regulator approved production signed packages only used in the gaming establishment that it supports. The Software Distribution Points (SDPs) 310 and 312 can communicate with Systems Management Points (SMPs) 314 and 316, respectively as well as directly to one or more gaming machines 318 and 320. The system allows for rapid and secure distribution of new games, configurations, and OS's from a centralized point. It makes it possible to update and modify existing gaming machines with fixes and updates to programs as well as providing modifications to such files as screen images, video, sound, pay tables and other gaming machine control and support files. It provides complete control of gaming machines from a centralized control and distribution point and can minimize the need and delay of human intervention at the gaming machine. In one embodiment, the configuration control may be from the SDPs 101 or 104 or from the gaming servers 103.

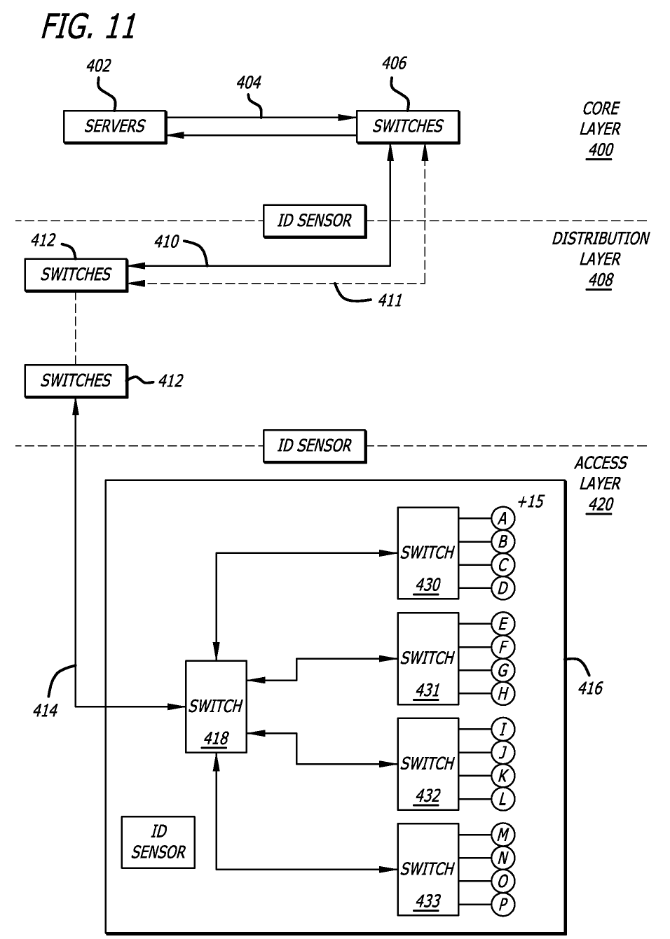

Another embodiment of a network that may be used in the system is illustrated in FIG. 11. A core layer 400 includes one or more servers 402 that are coupled via a communication path 404 to one or more switches 406. In one embodiment, the servers and switches of the core layer 400 are located within the gaming establishment premises in a secure administrative area. The servers 402 may, but are not required to be, game servers. The communication path 404 may be hardwire (e.g., copper), fiber, wireless, microwave, or any other suitable communication path that may be protected from attack. In one embodiment, the switches 406 are L2/L3 switches. However, one of ordinary skill in the art will appreciate that other types of switches may be used without departing from the scope or spirit of the claimed system.

A distribution layer 408 communicates with the core layer 400 via high bandwidth communications links 410. These links may be copper, fiber, or any other suitable link. If desired, redundant links 411 may be built into the system to provide more failsafe operation. The communications links couple the core layer switches 406 to the distribution layer switches 412. These may be one or more switches, such as L2 switches, for example.

The distribution layer 408 communicates with an access layer 420 via a high capacity communication link 414. The link 414 may be wire, fiber, wireless, or any other suitable communication link. In the embodiment of FIG. 11, the communication link 414 is coupled to a gaming carousel 416 that comprises a plurality of gaming machines (e.g., 16 gaming machines 400A-400P). A managed switch 418 is coupled to the link 414 to provide an interface switch to a plurality of other managed switches 430 through 433. In the embodiment illustrated, each of the managed switches 430-433 manages four game machines 415(x). It is understood that the types of switches may be changed without departing from the scope of the claimed system. Further, switches with more or fewer ports may be substituted and more or fewer tiers of switches in the access layer may be used, as well, without departing from the scope or spirit of the claimed system. In another embodiment, each game machine has its own managed switch.

In one embodiment of the gaming network, the network uses TCP/IP sessions between the gaming machines 415 and the servers 402. The TCP/IP sessions are used to exchange private information concerning game operations, game performance, network management, patron information, revised game code, accounting information, configuration and download, and other sensitive information. In one embodiment, sessions may be a single message and acknowledgement, or the sessions may be an extended interactive, multiple transaction session. Other instantiations may include UDP/IP, token ring, MQ, etc.

The example network is described in co-pending U.S. patent application Ser. No. 11/220,781 entitled Gaming Network and is incorporated herein by reference in its entirety. Another example network is described in co-pending U.S. patent application Ser. No. 11/530,880 entitled system for configuration, and is hereby incorporated herein by reference in its entirety. Any of the servers of FIGS. 10 and 11 could serve as the Configuration Server for use in the system.

The various embodiments described above are provided by way of illustration only and should not be construed to limit the claimed invention. Those skilled in the art will readily recognize various modifications and changes that may be made to the claimed invention without following the example embodiments and applications illustrated and described herein, and without departing from the true spirit and scope of the claimed invention, which is set forth in the following claims.

What is claimed:

1. A system for configuring a plurality of gaming devices on a communication network, each gaming device having an associated memory storing one or more game configuration packages for one or more game themes and denominations, said system comprising:
a configuration host storing game configuration packages;
a display associated with said configuration host, said host configured to control said display to display a list of approved default configuration packages;
apparatus for an operator at the host to (i) select a default configuration package from said displayed list for configuration of at least one selected gaming device and (ii) modify a default package to define an altered configuration package; and
said host configured to (i) verify that a selected default or altered configuration package is valid for said selected gaming device, (ii) specify a tag code for at least one default configuration package which corresponds to a game configuration package currently stored at least at said selected gaming device and (iii) over said network send a selected one of (a) said tag code to said gaming machine for enabling of said tagged default configuration at said first gaming device or (b) an altered package for re-configuration of said selected gaming device.

2. The system of claim 1 comprising said host is a gaming device.

3. The system of claim 1 comprising said host is a server remote to said gaming devices.

4. A method for configuring a plurality of gaming devices on a communication network, each gaming device having an associated memory storing one or more game configuration package including the configuration for one or more game themes and denominations, said method comprising:
arranging a configuration host for storing game configuration packages and for controlling a display to display a list of approved default configuration packages;
enabling an apparatus at the host for an operator to (i) select a default configuration package from said displayed list for configuration of at least one selected gaming device and (ii) modify a default package to define an altered configuration package; and
configuring the host for (i) verifying that a selected default or altered configuration package is valid for said selected gaming device, (ii) specifying a tag code for at least one default configuration package which corresponds to a game configuration package currently stored at least at said selected gaming device and (iii) over said network sending a selected one of (a) said tag code to said gaming machine for enabling of said tagged default configuration at said first gaming device or (b) an altered package for re-configuration of said selected gaming device.
